(19) United States
(12) Patent Application Publication
(10) Pub. No.: US 2014/0188634 A1
(43) Pub. Date: Jul. 3, 2014

(54) Sponsorship System

(71) Applicant: Anthony Puntoriero, Darling Point (AU)

(72) Inventor: Anthony Puntoriero, Darling Point (AU)

(73) Assignee: INSTANT SPONSOR.COM PTY LTD, Darling Point (AU)

(21) Appl. No.: 14/123,683

(22) PCT Filed: Mar. 7, 2012
(86) PCT No.: PCT/AU2012/000237

§ 371 Date: Mar. 3, 2014

(30) Foreign Application Priority Data
Jun. 3, 2011 (AU) 2011902207
Aug. 18, 2011 (AU) 2011903301

(51) Int. Cl. G06Q 30/02; G06Q 30/08; G06Q 30/06

(52) U.S. Cl. CPC G06Q 30/0275; G06Q 30/0613; G06Q 30/08; G06Q 30/0273; G06Q 30/0615
USPC 705/14.71; 705/26.41; 705/26.3; 705/14.69; 705/26.42

(57) ABSTRACT

A sponsorship method that includes the steps of: a) providing an electronic database including sponsorship opportunity information; b) allowing one or more potential sponsors to gain access to the sponsorship opportunity information, c) enabling the one or more potential sponsors to offer to purchase a sponsorship opportunity; d) using a data processor to determine, using one or more selection criteria, the suitability of the one or more potential sponsors to the sponsorship opportunity; and e) if the offer to purchase the sponsorship opportunity is accepted, using the data processor to generate a sponsorship agreement based on information in the electronic database and/or information entered into the electronic interface by the one or more potential sponsors.

### FIELD OF THE INVENTION

The present invention relates to a sponsorship system. In particular, the present invention relates to a computer-based athlete or event sponsorship system.

### BACKGROUND ART

Typically, athlete or event (sporting, social, cultural and the like) sponsorship is achieved through a series of negotiations. The sponsorship of events is often negotiated well in advance of the event and athletes are regularly signed to long-term sponsorship agreements. In addition, the cost of sponsoring an event or athlete can be extremely high, particularly for high profile athletes or events.

The effect of this sponsorship environment is that it is difficult for small or medium sized business to become involved in sponsorship. This may be particularly the case for long-terms sponsorship deals, which may be prohibitively expensive.

In addition, a small or medium sized business may not wish to sponsor an athlete at every event at which the athlete competes. This may be due to the cost associated, or due to the fact that the athlete may compete at events in locations (cities, countries etc) in which the sponsor has no market presence, and/or no intention of establishing a market presence. In the case of the latter, sponsoring an athlete at an event held where the sponsor has no market presence may be regarded as an unattractive waste of resources.

It will be clearly understood that, if a prior art publication is referred to herein, this reference does not constitute an admission that the publication forms part of the common general knowledge in the art in Australia or in any other country.

Throughout this specification, the term “comprising” and its grammatical equivalents shall be taken to have an inclusive meaning unless the context of use indicates otherwise.

### SUMMARY OF THE INVENTION

It is an object of the present invention to provide a sponsorship system which may overcome at least some of the abovementioned disadvantages, or provide a useful or commercial choice.

In one aspect, the invention resides broadly in a sponsorship method comprising the steps of:
a) providing an electronic database including sponsorship opportunity information;
b) providing an electronic interface to allow one or more potential sponsors to gain access to the sponsorship opportunity information, the electronic interface further allowing the one or more potential sponsors to offer to purchase a sponsorship opportunity;
c) using data processing means to determine, using one or more selection criteria, the suitability of the one or more potential sponsors to the sponsorship opportunity; and
d) if the offer to purchase the sponsorship opportunity is accepted, using the data processing means to generate a sponsorship agreement based on information in the electronic database and/or information entered into the electronic interface by the one or more potential sponsors.

Advantageously, the sponsorship method allows a potential sponsor to select sponsorship options that meet budgetary considerations and/or allow a user to target their sponsorship to most effectively benefit their corporate profile.

Further, the sponsorship method advantageously provides a computer- and/or internet-based system that places end consumers (sponsors) directly in touch with the product (sponsorship opportunity such as the athlete), in a real time market.

The electronic database may be of any suitable form. Preferably, the electronic database is stored on a computer, server or the like.

The electronic interface may be of any suitable type. It is envisaged, however, that the electronic interface may be provided as an Internet page which may be accessed using any suitable device. It will be understood that the devices used to access the electronic interface are not critical to the present invention.

A potential sponsor may be able to gain access to the sponsorship opportunity information simply by accessing the electronic interface. However, it is preferred that full access to the sponsorship opportunity information may only be available to potential sponsors that register with and/or subscribe to the database or Internet site. Thus, it is envisaged that some or all of the sponsorship opportunity information will only be available once a potential sponsor has accessed the electronic database through a secure link, password, or the like, or a combination thereof.

Any suitable sponsorship opportunity information may be provided. For instance, the sponsorship opportunity information may include one or more of the following: information regarding an athlete (name, career statistics, tournament schedule etc), information regarding an event (location, attendance statistics, schedule), information regarding the type of sponsorship (billboards, naming rights, athlete clothing, the location on an athlete's clothing etc), broadcast information (television, radio and/or online audiences) and the like, or any combination thereof.

While the present invention is described largely in terms of athlete sponsorship, it will be understood that the invention is not strictly limited to the sponsorship of athletes, and could be used for the sponsorship of any suitable person and/or organisation. For instance, sponsorship of sporting teams is envisaged, as is sponsorship of entertainers (musicians, actors, etc, and, in particular, entertainers attending particular events, such as awards ceremonies, film premieres or the like), people undertaking record attempts (for instance, around the world sailing), vehicles for motor racing, charity events, fashion shows or the like.

It is envisaged that the electronic interface may be provided with means to allow a sponsor to more rapidly locate sponsorship opportunity information that is of particular interest. For instance, the electronic interface may be searchable to allow a potential sponsor to search for sponsorship opportunity information on the basis of one or more criteria, such as, but not limited to, sponsorship price, event type (e.g. sporting, including specific types of sport, charity event, or the like), event location, event duration, estimated audience, the name of specific athletes, entertainers, sporting teams etc. It is also envisaged that a number of sponsorship opportunities may be provided within the same event. As an example purely for illustrative purposes, it is envisaged that a potential sponsor may be able to sponsor an athlete for only a portion of an event, such as sponsoring a golfer on fewer than the full four days of a golf tournament.

The offer to purchase the sponsorship opportunity may be of any suitable nature. For instance, the sponsorship opportunity may have a fixed price associated with it, and the first potential sponsor to offer to pay the fixed price may obtain the sponsorship opportunity. Alternatively, the sponsorship opportunity may be provided as an auction, such that the highest bidder in a particular timeframe (or, alternatively, until bidding reaches a predetermined value) will win the sponsorship opportunity.

In another embodiment, a potential sponsor may participate in an auction for a sponsorship opportunity through an automated bidding process. For example, the potential sponsor may set a starting bid, a maximum bid, and an incremental bidding amount for a specific sponsorship opportunity. The sponsorship system can automatically place bids for the sponsorship opportunity on behalf of the potential sponsor in response to competing bids. Each automatic bid would be an increase of the previous bid by the incremental bidding amount. Once the maximum bid is reached, the sponsorship system may stop bidding, and optionally alert the potential sponsor and provide an option for the potential sponsor to increase the maximum bid. Alternatively, if an automated bid made by the sponsorship system on behalf of a potential sponsor is a winning bid, the sponsorship system may alert the potential sponsor that he/she has won the sponsorship opportunity. The alert may be in the form of an SMS message, a email message, a voicemail message, or any other suitable type of notification.

In some embodiments of the invention, the bids made by potential sponsors may be anonymous. For instance, the potential sponsor may wish to remain anonymous (at least in the initial stages of bidding) to the athlete and/or other potential sponsors.

Any suitable data processing means may be provided. However, in a preferred embodiment of the invention, the data processing means comprises one or more computers.

Any suitable selection criteria may be used to determine the suitability of a potential sponsor to the sponsorship opportunity. For instance, the selection criteria may include one or more of the type of business operated by a potential sponsor, the nature of the logo, slogan or the like that the potential sponsor wishes to have displayed, whether the business or product of the potential sponsor is in conflict with any other existing sponsors of the athlete, event or the like, or any other conditions the sponsored entity wishes to apply to the sponsorship opportunity.

For instance, it is envisaged that some potential sponsors may have businesses that conflict with an athlete's or event's beliefs, codes of conduct or target audience. For instance, businesses promoting alcohol, tobacco, gambling or adult services may be incompatible sponsors for an event for which the target audience is primarily composed of children.

In addition, the businesses or products of some potential sponsors may be in conflict with legislation regarding the advertising of certain products (for instance, alcohol or tobacco) in some jurisdictions. Thus, it is envisaged that the data processing means may also determine the suitability of a potential sponsor to a sponsorship opportunity by accessing information regarding sponsorship legislation in particular countries, states, provinces or the like.

In some embodiments of the invention, the determination of the suitability of a potential sponsor to a sponsorship opportunity may be carried out only when the potential sponsor has purchased a sponsorship opportunity. Alternatively, the determination of the suitability of a potential sponsor to a sponsorship opportunity may be performed prior to allowing a potential sponsor to offer to purchase a sponsorship opportunity. In still further embodiments of the invention, the determination of the suitability of a potential sponsor to a sponsorship opportunity may be assessed prior to allowing the potential sponsor to access the sponsorship opportunity information. For instance, a potential sponsor may be required to apply for membership or registration prior to gaining access to the sponsorship opportunity information. In this way, undesirable or unwanted potential sponsors (for instance, due to the nature of the business operated by the potential sponsor or due to an inability to pay for sponsorship opportunities for which offers may be made) may be prevented from accessing the sponsorship opportunity information prior to prevent spurious or incompatible sponsorship offers.

In some embodiments of the invention, the determination of the suitability of a potential sponsor to a sponsorship opportunity may be carried out on the basis of compatibility information provided by the sponsor and/or the athlete (or organisation, event manager etc). In this embodiment, it is envisaged that the potential sponsor may provide certain compatibility information (for instance, when applying for membership or registration, when making an offer to purchase a sponsorship opportunity or when a sponsorship opportunity has been purchased) which may then be used to determine the suitability of the potential sponsor to the sponsorship opportunity. Any suitable information may be provided, such as the nature of the potential sponsor's business, the potential sponsor's other sponsorships, the potential sponsor's financial position, information regarding the ownership of the potential sponsor (if the potential sponsor is a corporation) and the like, or any combination thereof.

The athlete may also provide compatibility information. It is envisaged that the athlete's compatibility information may include information regarding the type of sponsors that the athlete would or would not be prepared to promote through sponsorship. The information may be provided on the basis of personal beliefs (for instance, a teetotaler may not wish to be sponsored by a sponsor that produces alcohol, a vegetarian may not wish to be sponsored by a sponsor that is involved with the sale of meat products and so on) or controversial sponsors (for instance, those associated with child labour, the manufacture of weapons, or sponsors based in countries governed by repressive regimes, or who have benefited from their association with repressive regimes).

In a preferred embodiment of the invention, the data processing means may compare the athlete's compatibility information with the potential sponsor's compatibility information and, based on the outcome of the comparison, may accept or reject the sponsorship offer. In addition, it is envisaged that the data processing means may request further information from either or both of the potential and the athlete if the compatibility information provided by one or both parties does not provide the data processing means with sufficient information to either reject or accept the sponsorship offer.

Once an offer to purchase a sponsorship opportunity has been accepted (i.e. when the data processing means has finished its determination of the suitability of a potential sponsor to a sponsorship opportunity and found no impediment to the proposed sponsorship) the data processing means may further generate a sponsorship agreement. The agreement may be of any suitable form, and may vary depending on the nature of the sponsorship and under which jurisdiction's laws the sponsorship agreement is to be made. In general terms, however, it is envisaged that the sponsorship agreement will take the form of a contract between the sponsor and the athlete or event manager or the like. Alternatively, the contract may be between the sponsor and the operator of the electronic database, or another party. In this embodiment of the invention, it is envisaged that the operator of the electronic database may have been delegated the authority to agree to sponsorship agreements on behalf of the athlete, event manager or the like.

It is envisaged that one or both of the parties negotiating the sponsorship agreement will be provided with an opportunity to add and/or remove clauses to the sponsorship agreement. It is envisaged that the data processing means may be provided with any suitable standard or common clauses which may be added to, or removed from, the sponsorship agreement as required. However, it is also envisaged that one or both parties may be provided with the ability to add further non-standard or more unusual clauses to the sponsorship agreement.

Any suitable further clauses may be added, and a skilled addressee will understand that the type and number of further clauses may be very large. For instance, and for illustrative purposes only, a potential sponsor may wish to include a clause whereby a portion of its sponsorship fee may be refunded if a golfer fails to make the cut at a particular tournament.

In another aspect the invention resides broadly in a sponsorship system comprising electronic data processing means containing sponsorship opportunity information, an electronic interface adapted to allow one or more potential sponsors to access the sponsorship opportunity information and make offers to purchase a sponsorship opportunity, wherein the data processing means are adapted to determine the suitability of the one or more potential sponsors to the sponsorship opportunity, and wherein the data processing means is further adapted to generate a sponsorship agreement based on information in the electronic database and/or information entered into the electronic interface by the one or more potential sponsors once the offer to purchase a sponsorship opportunity is accepted.

### BRIEF DESCRIPTION OF THE DRAWINGS

An embodiment of the invention will be described with reference to the following drawings in which:

FIG. 1 is a block diagram of an embodiment of an environment and architecture for the sponsorship system according to an embodiment of the invention.

FIG. 2 is a flow diagram depicting an embodiment of steps of a method for using the sponsorship system of FIG. 1.

FIG. 3 is an example of a web page of the web application of the sponsorship system according to an embodiment of the invention.

FIG. 4 is a flow chart illustrating the workflow of the web application according to another embodiment of the invention.

FIG. 5 is a flow chart illustrating the workflow of the Content Management System of the web application illustrated in FIG. 4.

### DETAILED DESCRIPTION OF THE DRAWINGS

It will be appreciated that the drawings have been provided for the purposes of illustrating a preferred embodiment of the present invention and that the invention should not be considered to be limited solely to the features as shown in the drawings.

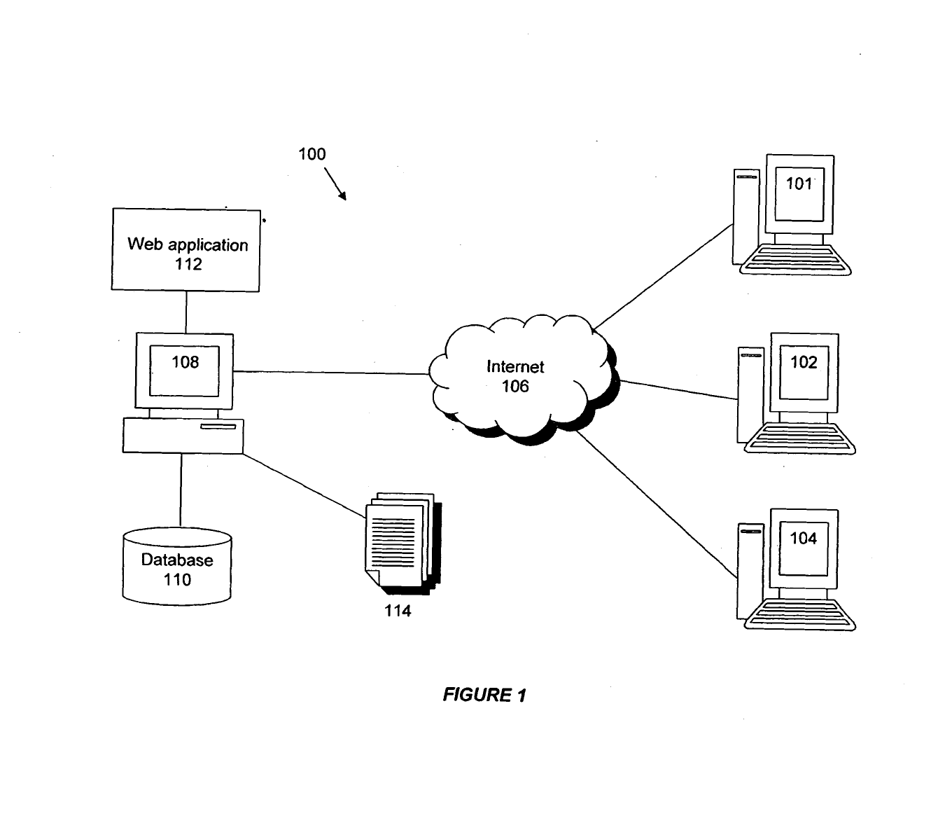

According to an embodiment of the present invention, there is provided an online sponsorship system 100 incorporating a web-server 108 (i.e. computational means) as shown in FIG. 1. The web-server 108 is configured to provide information, through an interactive web application 112, of sponsorship opportunities to one or more remote computers 101, 102 and 104 of potential sponsors. Examples of sponsorship opportunities include opportunities to sponsor celebrities/athletes, events, etc. The web-server 108 is also configured to query the potential sponsors about sponsorship information such as the brands and associated goods/services to be advertised. The interactive web application 112 is configured to receive bidding information for the available sponsorship opportunities from the potential sponsors via remote computers 101, 102 and 104 over a specified bidding period. At the end of the bidding period, the web-server 108 determines the highest bidder based on the bidding information and requests payment from the highest bidder. The web-server 108 generates a sponsorship contract 114 for the highest bidder based on the purchased sponsorship opportunity, the bidding information and the sponsorship information.

Referring to FIG. 1, there is depicted a block diagram of the sponsorship system 100. The sponsorship system 100 is based around a web-server 108 which executes software stored in memory. The software includes machine readable instructions provided on a suitable carrier, such as a magnetic or optical disk or in an integrated circuit electronic memory. The software includes one or more application modules to provide an interactive web application 112 to allow the potential sponsors to browse and select sponsorship opportunities for bidding via remote computers 101, 102 and 104. The one or more application modules are configured for obtaining information from the user, processing the information, transformation of data to produce a tangible output (i.e. the sponsorship contract), and database management.

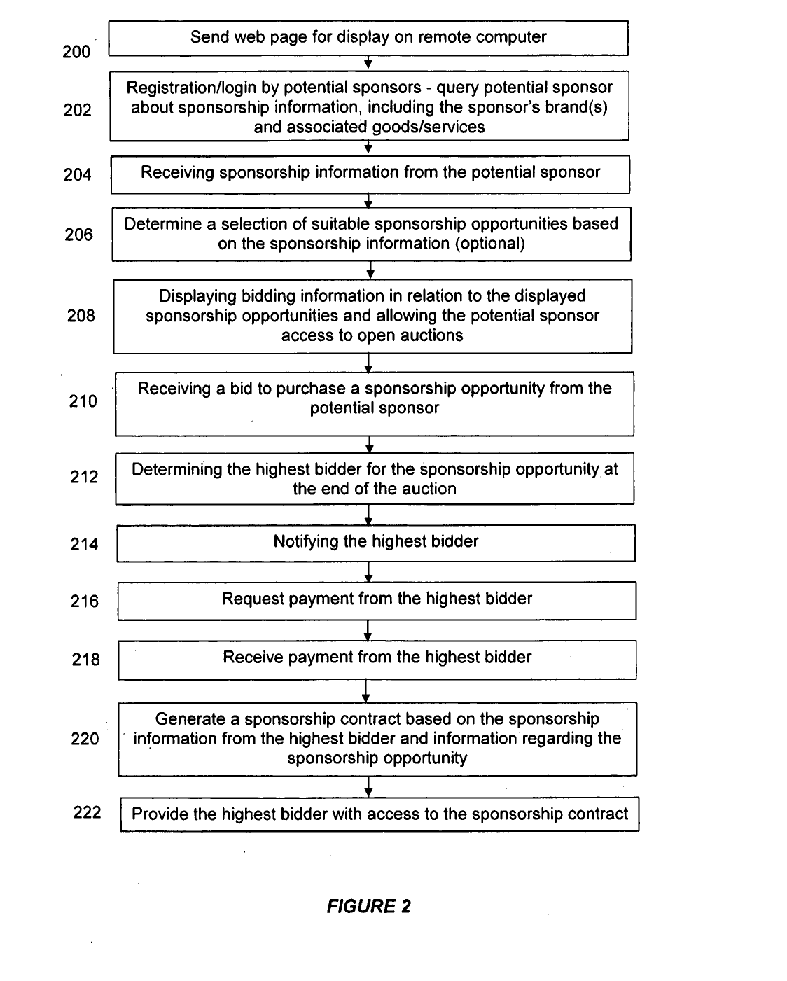

One or more processors of the server 108 execute the instructions in order to implement the sponsorship method described in detail below with reference to FIG. 2. The one or more processors would be sufficient for handling network traffic to the web application site 112 and the execution of components of the web application for connected users (potential sponsors).

The web-server 108 includes a storage device defining a template database 110 for storing information relating to sponsorship opportunities, memberships and sponsorship contracts.

A sponsorship method performed using the online sponsorship system 100 is now described with reference to FIG. 2.

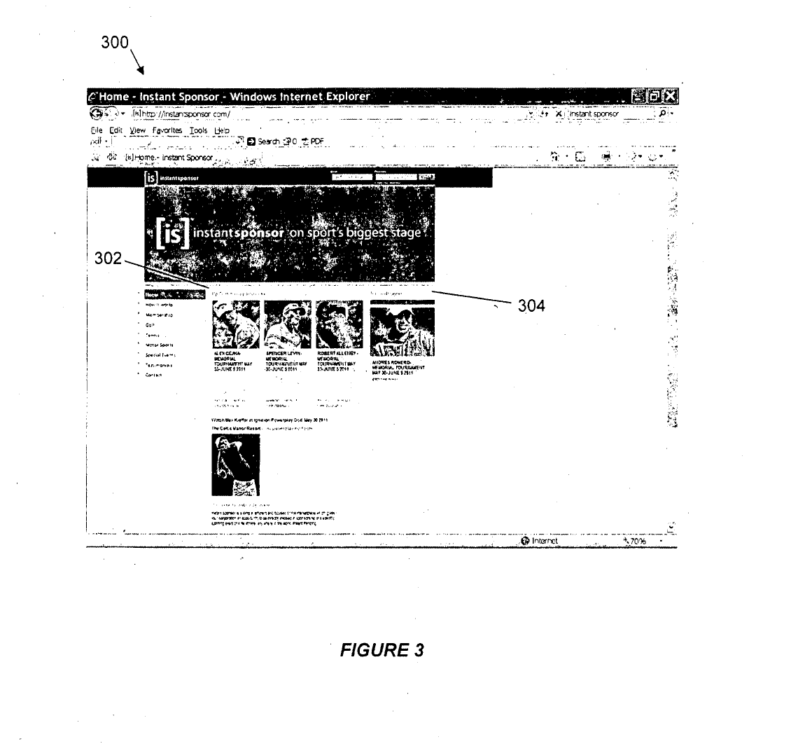

At step 200, a main website hosted on web-server 108 is connected to a potential sponsor's remote computer 101, 102 and/or 104. The web-server 108 sends a web-page 300 for display on the remote computers 101, 102 and/or 104 (see FIG. 3). The web-page 300 includes information about upcoming and currently available sponsorship opportunities 302, 304. Respective links are provided to enable a potential sponsor to select the link(s) using a mouse of the remote computer 101, 102 or 104 to view detailed information relating to a specific sponsorship opportunity.

To participate in the bidding process for a specific sponsorship opportunity, the potential sponsor must register with the website to become a member or login as a registered member. During the registration process at step 202, the web-server 108 queries the potential sponsor information such as contact information and information relating to the brands) and associated goods/services for advertisement.

At step 204, sponsorship information is received by the web-server 108 from the potential sponsor during the registration process. This information is stored in the database 110.

Step 206 is an optional step. In one embodiment, the potential sponsor is granted access to bid on all available sponsorship opportunities. In another embodiment, the web-server 108 determines a selection of suitable sponsorship opportunities based on the sponsorship information received, and the potential sponsor is only granted access to the suitable sponsorship opportunities. For example, some sponsorship opportunities may not be suitable for certain potential sponsors if there is an existing sponsorship contract in place with a competing sponsor for a related sponsorship opportunity. Related sponsorship opportunities may include two or more celebrities/athletes being sponsored at the same event, or different parts of a celebrity/athlete's clothing available for sponsorship. In a further embodiment, celebrities/athletes and/or event organisers may specify sponsorship criteria to be stored in the database 110. For example, some celebrities/athletes may not be able to receive sponsorship from specific brand owners due to personal and/or contractual reasons. This type of information may be stored as sponsorship criteria in the database 110 and once the potential sponsor has registered or logged in to a remote computer 101, 102, 104, the potential sponsor is only granted access to suitable sponsorship opportunities. The suitable sponsorship opportunities being determined based on the sponsorship information of the potential sponsor and sponsorship criteria related to the sponsorship opportunities.

At step 208, the web-server 108 displays bidding information relating to the sponsorship opportunities and enables the potential sponsor access to place one or more bids. Bidding information includes information relating the current bid and the time remaining for the bid.

At step 210, the web-server receives one or more bids from the potential sponsor and updates the bidding information stored on the database 110.

At step 212, the highest bidder for a sponsorship opportunity is determined at the end of the respective auction period.

At step 214, the web-server 108 notifies the highest bidder that he/she has won the sponsorship opportunity. The notification can be sent in any suitable form, such as by email, fax, post and/or telephone.

At steps 216 and 218, the web-server 108 requests payment from the winning bidder and sends a payment details web-page to the remote computer 101, 102 or 104 of the winning bidder. Once the winning bidder has entered payment (e.g. credit card, BPAY, etc.) details to purchase the sponsorship opportunity into the payment details web-page, the web-server 108 facilitates the transfer of funds between the winning bidder and the financial institution(s) for the trader(s) of the sponsorship opportunity.

In another embodiment, the web server 108 redirects the web-browser running on remote computer 101, 102 or 104 to a financial transaction server (not shown) for the transfer of funds.

At step 220, the web-server 108 generates a sponsorship contract 114 between the winning bidder and the trader of the sponsorship opportunity based on the wining bid amount, the sponsorship information and the sponsorship opportunity.

At step 222, the winning bidder can access and print the sponsorship contract. In one embodiment, the winning bidder is provided with a hyperlink for a predetermined length of time, before the web-server 108 withdraws the access to the sponsorship contract. In another embodiment, a hard copy of the sponsorship contract is posted to the winning bidder by an administrator.

FIG. 3 illustrates a web page of the web application 112, which includes a user interaction module that provides a user interface for a potential sponsor to interact with the sponsorship system. Typically, a different interface is provided for an administrator of the web application 112. For example, an administrator of the web application 112 would be given more access, such as access to edit, update and manage the layout of information relating to sponsorship opportunities.

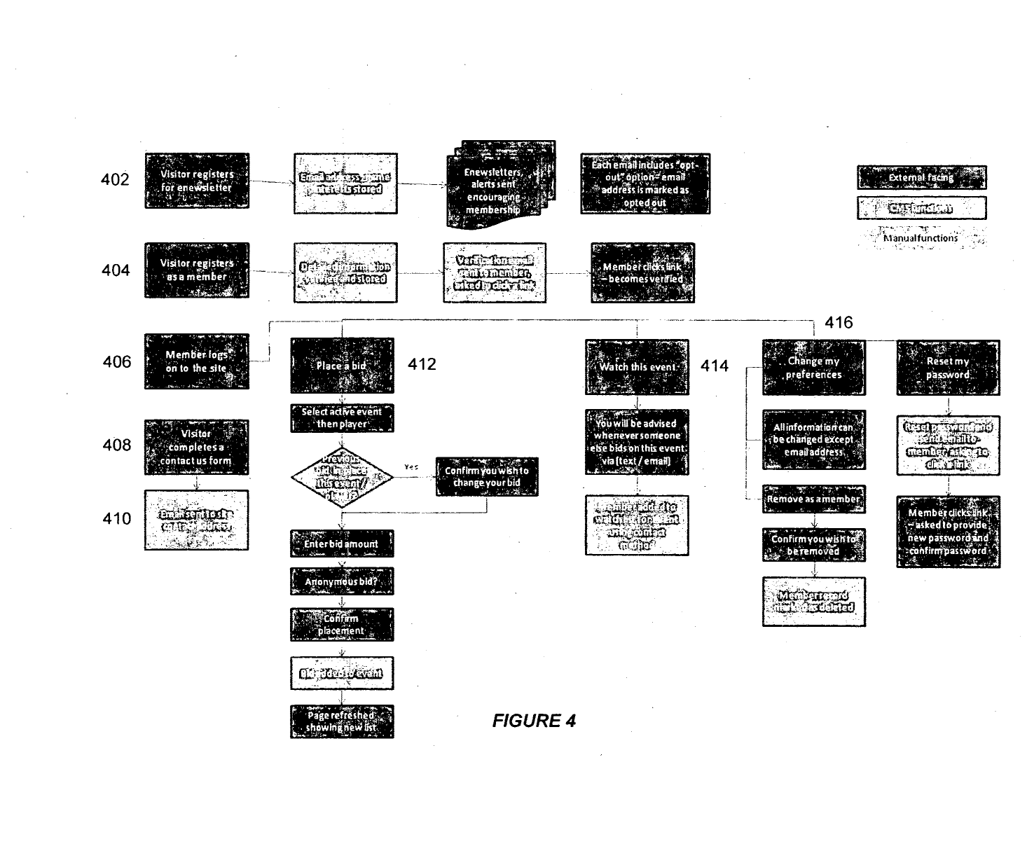

FIG. 4 illustrates the workflow of a web application according to another embodiment of the present invention. In this embodiment, the web application may interact with a user differently in different scenarios as described in further detail below. The web application has a Content Management System (CMS), which carries out a number of functions for the web application.

In scenario 402, if a visitor subscribes to e-newsletters on the web application, the visitor is prompted to fill in a sign-up form, which contains fields such as email address, contact name and interests. This information is then stored in the database. Once the sign up process is complete, the visitor will receive e-newsletters on a regular basis. Alerts will also be sent to encourage the visitor to register as a member of the web application. Typically, alerts may contain information such as sponsorship opportunities, which are related to the interests of the visitor.

Each email sent to the visitor from the web application includes an option for the visitor to click on to unsubscribe to the e-newsletter and/or alerts. If the visitor elects to unsubscribe, the visitor's email is marked in the system of the web application as ‘unsubscribed’ or ‘opted out’.

In scenario 404, a visitor may register on the web application as a member. In this scenario, the web application prompts the visitor to fill in a registration form, which contains the following fields:
Title
First name *
Last name *
Company name
Street address *
Date of Birth
Gender
Email address *
Confirm email address *
Password *
Contact mobile for SMS alerts *
Preferred method of alerts—mobile/email *
I want my bids to be anonymous *
Preferred currency *
Preferred language *
Timezone *
Preferred payment method
Email update flag
Interest category (5 categories) *
Member corporate logo (via upload)

Typically, the fields marked with “*” are compulsory; the email address may be used as the unique identifier; the field of whether the bids are to be anonymous may be set or reset for each sponsorship opportunity; the visitor must choose at least one interest category; and the corporate logo to be sponsored can be uploaded onto the web application. The CMS verifies the information entered by the visitor and stores the information in a database.

CMS then sends a verification email to the visitor, the verification email containing a verification link. Once the visitor opens the email, the visitor will be asked to click on the verification link. Once the visitor clicks on the verification link, the visitor successfully registers as a member of the web application.

In scenario 406, a member logs on to the web application. Once a member has logged on, the member can place a bid 412, watch an event 414 and change preferences 416.

If the member chooses to place a bid 412, the member can select a sponsorship opportunity, i.e. an event and/or an athlete of interest for bidding. If the member has already placed an existing bid on the sponsorship opportunity, the web application will ask the member for confirmation that he/she wishes to change his/her bid. If there is no existing bid or confirmation to change bid is received, the member will be prompted to enter the bid amount. The web application will also enquire whether the bid should be anonymous. If the member selects the anonymous option, the member's details will not be disclosed in the list of bids. If the member does not select anonymous, the member's details will be displayed in the list of bids. Before the bid is finalised, the member will be asked to confirm the bid. Once confirmation is received, the bid will be added to the list of bids for the sponsorship opportunity. The relevant web-page for the sponsorship opportunity will be refreshed to display the new list of bids.

If the member chooses to watch a sponsorship opportunity, i.e. an event and/or an athlete, the member will be alerted when a new bid has been places on the sponsorship opportunity. The CMS adds the member onto the watch list corresponding to the sponsorship opportunity and the member may be alerted using a preferred contact method, if set by the member. A number of different sponsorship opportunities may be watched at once. The member may be alerted directly by SMS and/or email, and/or a message/alert may be accessed by the member once he/she is logged in.

If the member chooses to change preferences 416, the member will be given access to change any information except the email address. If the member wishes to be removed as a member, the web application will seek confirmation of the removal. Once confirmation is received, details of the member will be marked as deleted in the CMS.

If the member chooses to reset his/her password, CMS will reset the password and send an email to the member with a password link. Once the member clicks on the link, the member will be prompted to provide a new password and confirmation of the new password. Once this is completed, the new password is set.

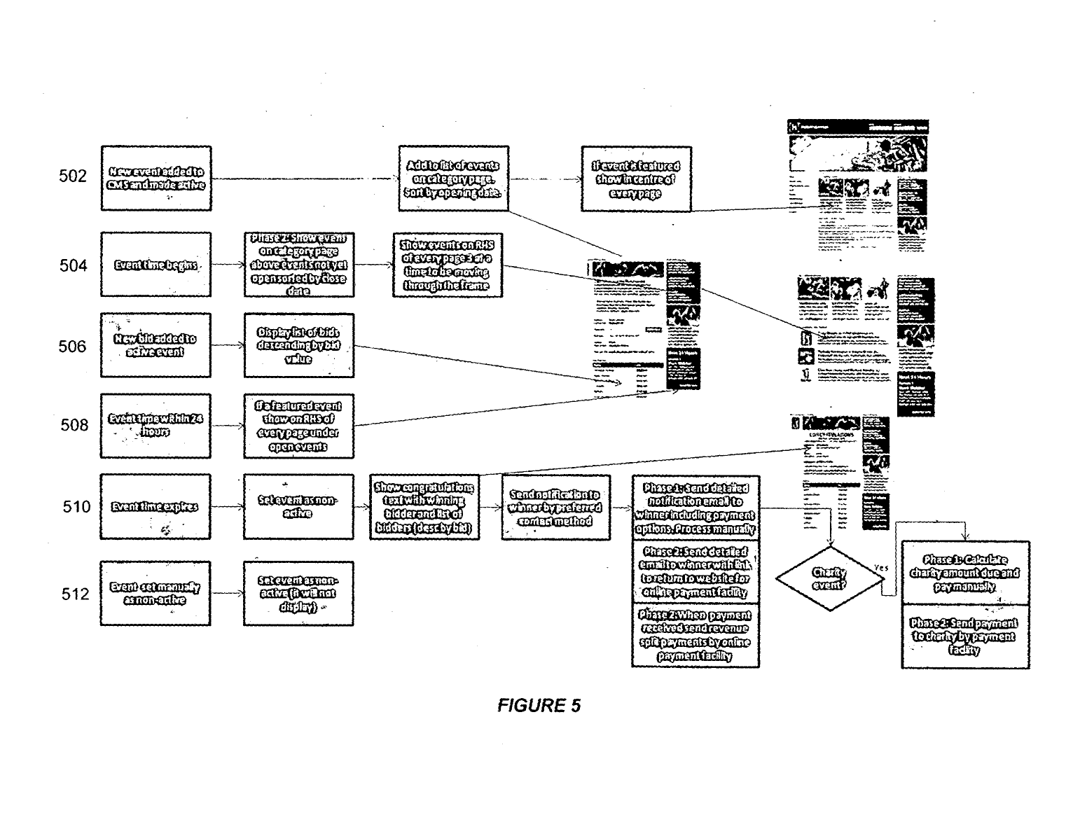

Now referring to FIG. 5, which illustrates the functions of the Content Management System (CMS) for the web application as described in FIG. 4. The Content Management System processes and manages the content of the web application and also allows an administrator to manage and maintain the content of the web application.

As shown in FIG. 5, if a new sponsorship opportunity, such as an event, is added to the CMS and made active 502, a summary of information relating to the sponsorship opportunity is displayed on a page of the web application. The sponsorship opportunities listed on that page may be sort in date order.

Certain sponsorship opportunities may be set as featured events. These featured events may be displayed on every page of the web application. Typically, a total of three featured events will be displayed at one time.

If an auction for a sponsorship opportunity begins 504 (i.e. the sponsorship opportunity becomes active), information relating to the sponsorship opportunity will be shown on a category page above upcoming sponsorship opportunities. The sponsorship opportunities on the category page may be sort in order of the closing date for the action.

Information relating to the sponsorship opportunity may contain the following fields:
Name of the sponsorship opportunity
Description of the sponsorship opportunity
Image(s) relating to the sponsorship opportunity
Name of the match/tournament (if applicable)
Description of the match/tournament
The reserve amount
Start date and time of the auction
End date and time of the auction

A summary of the sponsorship opportunities open for bidding may be displayed on a side or corner of one or more web pages of the web application, for example, the right hand side of one or more web pages. Each summary may be linked to a different page showing further detail about the sponsorship opportunity.

When a new bid is added to an active sponsorship opportunity 506, information relating to the new bid is added to a list of descending bids displayed in relation to the active sponsorship opportunity.

At the same time, when a new bid is made, CMS stores the following details in a bid table:
Name of the sponsorship opportunity
Description of the sponsorship opportunity
Email address of the bidder
Whether the bid is to be anonymous
Date and time of the bid
Whether the bid is a current bid or a replaced bid
The amount of the bid
The identification reference number of the bid

If the sponsored opportunity is a charity event, the amount to be donated to the relevant charity will also be updated for display in association with the sponsorship opportunity.

If the auction for a features sponsorship opportunity is due to being within the next 24 hours 508, a summary of the details of the sponsorship opportunity can be shown in a portion, such as the right hand side of one or more web pages. The summary may contain a link which enables a visitor or member to register for the featured sponsorship opportunity, so the visitor/member can be updated on any information relating to the sponsorship opportunity.

Once an auction expires 510, CMS sets the expired sponsorship opportunity as ‘non-active’. The web application will show congratulatory text with the winning bidder and list of bidders in order of descending bidding amount. Notification will be sent to the winning bidder via a preferred contact method if set, or SMS and/or email.

An identification reference number will be allocated to the winning bid. The identification reference number is then stored in the bid table. The identification reference number will be included in the notification, which is sent to the winning bidder.

Typically, the notification will also contain payment options. Payment of the bid may be processed manually, if preferred by the member. Alternatively, information relating to online payment can be sent to the winning bidder, for example, a link may be sent to the winning bidder and the winning bidder may be led to an online payment page via a payment link.

Once payment is received, the payment can be processed accordingly. For example, a portion of the payment may be forwarded to the host of the sponsorship opportunity, a portion of the payment may be forwarded to an account for the business associated with the web application, and/or a portion or all of the payment may be forwarded to a charity.

Revenue splitting options may be based on a percentage to be paid to athletes, owners, sporting bodies, etc.

If the sponsorship opportunity is a charity event, CMS may calculate the payment amount due for the appropriate charity/charities and payment can be made manually, or automatically.

Different sponsorship opportunities can be organised and displayed on the web application in different categories. For example, some categories may include cricket, soccer, motor racing, tennis and special events, etc.

An administrator can manage and maintain contents of the web application through the CMS by adding, amending and/or removing specific information relating to sponsorship opportunities. An administrator may also add new sponsorship opportunities and delete sponsorship opportunities. Typically, the following information in relation to a sponsorship opportunity can be added, amended or removed:
Name of the sponsorship opportunity (i.e. event name, for example Ashes 2010, Cricket—second test in Adelaide)
Description of the sponsorship opportunity (i.e. England cricket team tour of Australia 2010; Dec. 2 to Dec. 6, 2010, Adelaide oval)
Image relating to the sponsorship opportunity (i.e. the Ashes logo)
Category of the sponsorship opportunity (i.e. cricket)
Whether the sponsorship opportunity is active
Whether the sponsorship opportunity will be a featured event
If the sponsorship opportunity is a charity event, the name of the charity
If the sponsorship opportunity is a charity event, the percentage of bid to be paid to the charity
Name relating to the auction (e.g. Australian gloves sponsorship)
Description of the auction (e.g. Your logo can appear on the Australian batting gloves)
Image relating to the auction (can be uploaded by the administrator)
The reserve amount (e.g. $10,000)
Start date and time of the auction
End date and time of the auction
Whether the auction is active
Display position of the auction on a page of the web application
The value of the current bid
The value of the winning bid
The name of the ‘owner’ of the sponsorship opportunity e.g. Cricket Australia)
Percentage of payment allocated to ‘owner’ of the sponsorship opportunity
Percentage of payment allocated to a sponsored athlete
Name of a sporting body, if applicable (e.g. South Australian Redbacks)
Percentage of payment allocated to a sponsored sporting body
Reference number for a winning bid

A form may be used by an administrator to update and manage the above information.

The web application may also have links to social networking websites, such as Facebook and Twitter.

Those skilled in the art will appreciate that the present invention may be susceptible to variations and modifications other than those specifically described. It will be understood that the present invention encompasses all such variations and modifications that fall within its spirit and scope.

1. A sponsorship method comprising the steps of:
a) providing an electronic database including sponsorship opportunity information;
b) allowing one or more potential sponsors to gain access to the sponsorship opportunity information,
c) enabling one or more potential sponsors to offer to purchase a sponsorship opportunity;
d) using data processing means to determine, using one or more selection criteria, the suitability of the one or more potential sponsors to the sponsorship opportunity; and
e) if the offer to purchase the sponsorship opportunity is accepted, using the data processing means to generate a sponsorship agreement based on information in the electronic database and/or information from the one or more potential sponsors.

2. The method as claimed in claim 1, further comprising the step of displaying the sponsorship opportunity information on an electronic interface.

3. The method according to claim 1, further comprising providing user accounts to allow the one or more potential sponsors to register as members.

4. The method as claimed in claim 3, wherein the step of allowing one or more potential sponsors to gain access to the sponsorship opportunity information is only available once the one or more potential sponsors have registered as members.

5. The method according to claim 1, wherein the sponsorship opportunity information includes one or more of the following:
information regarding a celebrity;
information regarding an event;
information regarding the type of sponsorship; and
broadcast information.

6. The method as claimed in claim 5, wherein the celebrity is an athlete.

7. The method according to claim 1, wherein the offer to purchase the sponsorship opportunity is an offer to purchase at a fixed price.

8. The method according to claim 1, further comprising the step of creating an auction for the sponsorship opportunity, wherein the offer to purchase the sponsorship opportunity is a bid at the auction.

9. The method as claimed in claim 8, wherein the bid is automatically placed on behalf of a potential sponsor based on bidding information specified by the potential sponsor.

10. The method as claimed in claim 9, wherein the bidding information comprises a starting bid amount, a maximum bid amount and an incremental bidding amount.

11. The method as claimed in claim 9, the method comprising the steps of
placing the bid based on a starting bid amount;
in response to a competing bid, placing a new bid based on the starting bid amount plus one or more incremental bidding amounts.

12. The method as claimed in claim 11, further comprising the step of checking whether the new bid exceeds a maximum bid amount before placing the new bid.

13. The method according to claim 1, further comprising the step of keeping the one or more potential sponsors anonymous.

14. The method according to claim 1, wherein the one or more selection criteria includes one or more of the following:
preferences associated with the sponsorship opportunity,
a type of business operated by a potential sponsor,
a nature of a trade mark or slogan of the potential sponsor, and
conflict of interest.

15. A sponsorship method comprising the steps of:
providing, via computational means, sponsorship opportunity information;
allowing one or more potential sponsors to access the sponsorship opportunity information,
enabling the one or more potential sponsors to offer to purchase a sponsorship opportunity;
obtaining branding information from the one or more potential sponsors,
selling the sponsorship opportunity to a sponsor,
displaying the branding information of the sponsor at the sponsorship opportunity.

16. The method as claimed in claim 15, wherein the sponsorship opportunity is associated with a celebrity's clothing and/or accessories, and the step of displaying is displaying the branding information on the celebrity's clothing and/or accessories.

17. The method according to claim 16, wherein the celebrity is an athlete.

18. The method according to claim 15, the method comprising the step of creating an auction for the sponsorship opportunity.

19. A sponsorship system comprising
electronic data processing means containing sponsorship opportunity information,
an electronic interface configured to allow one or more potential sponsors to access the sponsorship opportunity information and make offers to purchase a sponsorship opportunity,
wherein the data processing means are configured to determine a suitability of the one or more potential sponsors to the sponsorship opportunity, and
wherein the data processing means is further configured to generate a sponsorship agreement based on information in the electronic data processing means and/or information entered into the electronic interface by the one or more potential sponsors once an offer to purchase a sponsorship opportunity is accepted.
